(19) United States
(12) Patent Application Publication
(10) Pub. No.: US 2009/0144056 A1
(43) Pub. Date: Jun. 4, 2009

(54) Method and computer program product for generating recognition error correction information

(76) Inventors: Netta Aizenbud-Reshef, Haifa (IL); Ella Barkan, Haifa (IL); Eran Belinsky, Haifa (IL); Jonathan Joseph Mamou, Jerusalem (IL); Yaakov Navon, Ein Vered (IL); Boaz Ophir, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/946,847

(22) Filed: Nov. 29, 2007

(51) Int. Cl. G10L 21/00

(52) U.S. Cl. 704/228; 704/E15.039

(57) ABSTRACT

A method for providing recognition error correction information, the method includes: obtaining metadata associated with a capture of a media item; and generating recognition error correction information in response to the metadata. The recognition error correction information is to be used in a recognition process selected out of a list consisting of an automatic speech recognition process and an optical characters recognition process.

### FIELD OF THE INVENTION

The present invention relates to methods and computer program products for generating recognition error correction information.

### BACKGROUND OF THE INVENTION

It is desired to extract textual information from images or from speech signal sequences captured by various capture devices such as mobile phones equipped with a camera and/or a recorder.

The information extraction is problematic due to various reasons including for example, absence of a-priory information about the printing layout of the textual information, fonts of the textual information are at different sizes and types, the textual information is embedded within graphics, and image capture limitations such as perspective distortions, limited illumination as well as image wrapping and misalignment.

When OCR (Optical Character Recognition) is applied on such images the results are expected to be poor.

One of the known methods used to correct OCR results is by using predefined dictionaries. The correction quality is heavily based on the relevancy of the dictionaries to the processed text. Typical dictionaries can include only a portion from the human knowledge and usually do not include dynamically changing information as well as names of persons, companies, products and the like.

One can also record speech annotations. The classical approach consists of converting the speech to word transcripts using a large vocabulary continuous speech recognition (LVCSR) tool. However, a significant drawback is that Out-Of-Vocabulary (OOV) terms, i.e. term that are missing words from the Automatic Speech Recognition (ASR) system vocabulary, cannot be recognized and are replaced in the output transcript by alternatives that are probable, given the recognition acoustic model and the language model. In many applications, the OOV rate may get worse over time unless the recognizer's vocabulary is periodically updated.

There is a need to provide efficient methods and computer program products that can improve speech recognition and optical character recognition processes.

### SUMMARY

A method for providing recognition error correction information, the method includes: obtaining metadata associated with a capture of a media item; and generating recognition error correction information in response to the metadata.

### BRIEF DESCRIPTION OF THE DRAWINGS

The present invention will be understood and appreciated more fully from the following detailed description taken in conjunction with the drawings in which:

FIG. 1 illustrates a method for providing recognition error correction information according to an embodiment of the invention;

FIGS. 2-4 illustrate methods for providing recognition error correction information according to an embodiment of the invention; and

FIG. 5 illustrates a system for providing recognition error correction information according to an embodiment of the invention.

### DETAILED DESCRIPTION OF THE DRAWINGS

The term “media item” includes be a picture (image), a video stream, audio-visual stream or an audio stream. The media item can be captured by a capture device such as a camera or an auditory recorder. It is noted that a single capture device can include a camera and an auditory recorder. It is noted that multiple media items can be acquired by one or more capturing devices and that a processing stage provides a single media item that is then being recognized.

A method and computer program product for generating recognition error correction information is provided. This information can form a dictionary or added to a pre-defined dictionary of words that can be used for correcting optical character recognition (OCR) errors. The recognition error correction information can assist in selecting between multiple existing words of a dictionary. Additionally or alternatively, this information can be used to correct errors in an automatic speech recognition (ASR) tool by enriching its vocabulary.

According to an embodiment of the invention the recognition error correction information is responsive to the context of a captured media item. For example—the information error correction information can be obtained in response to media item capture location, media item capture time, an identity of an owner of a capture device or the capture device setting can be used for retrieving recognition error correction information from relevant data structure.

Conveniently, dictionaries for OCR correction are compiled based on media item metadata and personal user information. For example, if the media item capture location (included in the metadata) indicates that the image was captured at a conference site, and if the user's calendar indicates that the user was expected to attend a certain lecture at the media item capture time then the recognition error correction information (such as a dictionary) that is used for correcting errors of the OCR process can include words related to the lecture and, additionally or alternatively, to the conference.

Conveniently, recognition error correction information is used to enrich a language model of a ASR tool. For example, if the media item capture location (included in the metadata) indicates that a speech signal was captured at a conference site, and if the user's calendar indicates that the user was expected to attend a certain lecture at the media item capture time then the recognition error correction information (such as a dictionary) that is used for correcting errors of the ASR can include terms related to the lecture and, additionally or alternatively, to the conference.

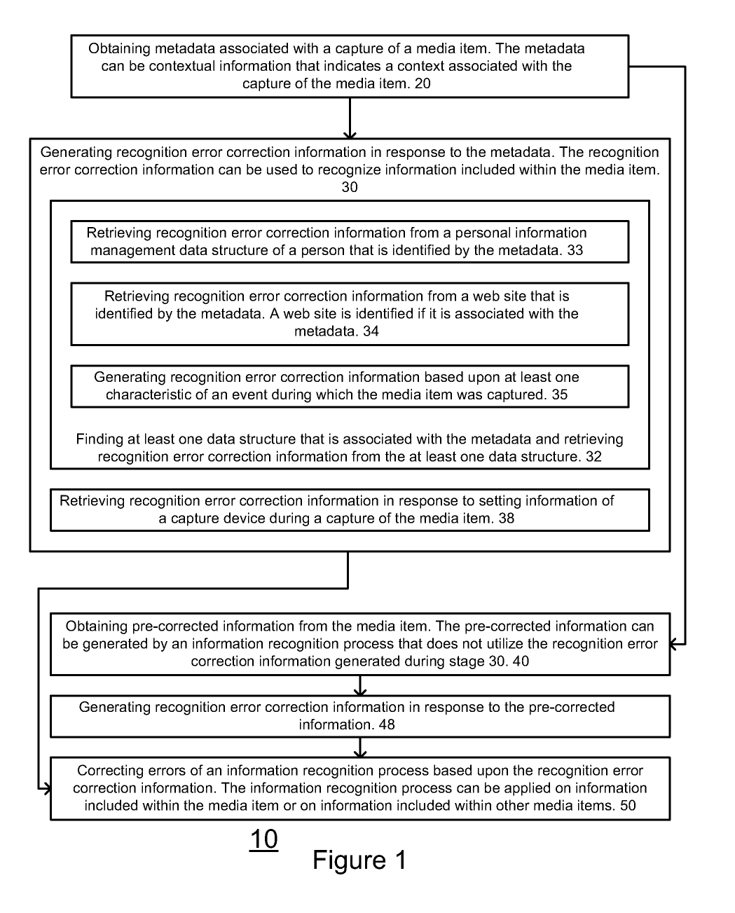

FIG. 1 illustrates method 10 for providing recognition error correction information according to an embodiment of the invention.

Method 10 starts by stage 20 of obtaining metadata associated with a capture of a media item. The metadata can be contextual information that indicates a context associated with the capture of the media item. Accordingly, this metadata can also be referred to as contextual metadata. It is noted that the contextual metadata can be obtained in relation to multiple media items that are captured substantially together.

The metadata may describe the media item capture location, the media item capture location, the media item capture time, capture device settings, name of person that is associated with the capture device (for example—the owner of the capture device), the orientation of a camera when an image was captured, capture device manufacturer, capture device model, and the like.

Metadata can be of various formats including but not limited to Exif, TIFF, TIFF/EP and DCF compliant metadata formats.

The metadata can be generated by the capturing device. For example, media item capture location can be generated by the capture device (for example a mobile camera equipped with Global Positioning System capabilities).

Additionally or alternatively, metadata can be generated by another system such as a cellular network that can determine the location of a mobile phone. The media item capture location can also be deducted from the location of stationary devices that communicate via short range communication with the capture device. Such stationary devices can be installed in buildings or outdoors.

Additionally or alternatively, metadata can be provided by the user of the capture device.

Stage 20 is followed by either one of stage 30 and stage 40. FIG. 1 illustrates both stages but method 10 does not necessarily include both stages.

Stage 30 includes generating recognition error correction information in response to the metadata. The recognition error correction information can be used to recognize information included within the media item. It is noted that recognition error correction information generated in response to one media item can be used for correcting errors of a recognition process that is applied on another media item. These media items can be acquired by the same person, acquired at the same location, acquired at the same time, but this is necessarily so. User behavioral patterns can be learnt (or received) and used to determine when to apply recognition error correction information obtained by the user.

Stage 30 conveniently includes stage 32 and additionally or alternatively, stage 38.

Stage 32 includes finding at least one data structure that is associated with the metadata and retrieving recognition error correction information from the at least one data structure.

The association between the metadata and the data structure can be learnt from at least one of the following or a combination thereof: the media item capture location, from the media item capture time, from capture device settings, from a person that is identified by the metadata.

The data structure can be owned by the person that is the owner of the capture device, can be a data structure that can be accessed by that person and the like. The data structure can be stored at the user computer, at servers, at shared network storage and the like.

The data structure can be a personal information management (PIM) data structure, a collaborative tool data structure, an email message, a document attached to an email, a calendar data structure, a document related to an activity of the person, a data structure that includes information about the person, a data structure that includes information about a participant of a certain event during which the media item was obtained, a data structure that includes information about an event that is published by publishing information (such as information included in a poster) captured by the capture device, a data structure that includes information about an object (such as a building, restaurants, playgrounds, museums, services) positioned in proximity to the media capture location; a data structure that includes information about an object (such as building, business, advertisement) in which the media item was captured, and the like.

It is noted that multiple data structures can be associated with the metadata (and especially but not necessarily with different parts or fields of the metadata). In this case the recognition error correction information retrieved from different data structure can be merged, fused or otherwise process in order to provide recognition error correction information. For example, the recognition error correction information from different data structure can be aggregated. Yet for another example, contradiction between recognition error correction information (for example—two different spelling to the same object) from different data structures can be resolved in various manners including evaluation of a reliability of the different data structures and resolving contradictions by relying on more reliable recognition error correction information.

The data structures can also include personal blog posts, can include information about the activities of the user (e.g. meetings, conferences, a meeting's title and attendee list, documents related to user activities, etc) and the like.

Stage 32 can include at least one of stages 33-35 or a combination thereof.

Stage 33 includes retrieving recognition error correction information from a personal information management data structure of a person that is identified by the metadata. The retrieving is responsive to a media item capture time and additionally or alternatively to a media item capture location.

Stage 34 includes retrieving recognition error correction information from a web site that is identified by the metadata. A web site is identified if it is associated with the metadata. Some examples of such association are listed above. Metadata can be used for searching an associated web site.

Typically, web search engines provide a relevancy score to each web site search result. These relevancy scores can be used to filter out irrelevant web sites (for example web site that their relevancy rank is below a threshold). The filter can also limit the number of web sites from which recognition error correction information can be obtained. Such a limitation can reduce the processing burden and speed up the retrieval of recognition error correction information.

Stage 35 includes generating recognition error correction information based upon at least one characteristic of an event during which the media item was captured.

Stage 38 includes retrieving recognition error correction information in response to setting information of a capture device during a capture of the media item. For example, if an image was captured during a “macro” mode of the camera then the image probably includes a small text area (for example—business card, brochure) and data structures that are expected to include this type of information (such as business card data base, or phone book) can be searched for recognition error correction information. Yet for another example, light related metadata (such as exposure time, shutter speed, light source, flash on/off) can indicate whether a captured image was taken indoor or outdoor. Dark images are expected to be taken outdoor and during the evening. In addition the orientation of a camera (upwards or downwards) can provide an indication about the size of an imaged object (for example—upward inclination can indicate that a large object such as a street's advertisement is captured.

Stage 40 includes obtaining pre-corrected information from the media item. The pre-corrected information can be generated by an information recognition process that does not utilize the recognition error correction information generated during stage 30. The pre-corrected information can be a result of an OCR process, a raw (pre-corrected) transcription result. In both cases pre-corrected information can include correct information that can be used for detecting relevant data structures.

Stage 40 is followed by stage 48 of generating recognition error correction information in response to the pre-corrected information.

Stage 48 can include finding at least one data structure that is associated with the pre-corrected information and retrieving recognition error correction information from the at least one data structure. Stage 48 can be analogues to stage 32 but differs by being responsive to an association between pre-corrected information (and not metadata) and at least one data structure.

Stages 48 and 30 are followed by stage 50 of correcting errors of an information recognition process based upon the recognition error correction information. The information recognition process can be applied on information included within the media item or on information included within other media items.

It is noted that method 10 can start by capturing a media item or by receiving a media item that was captured by another process.

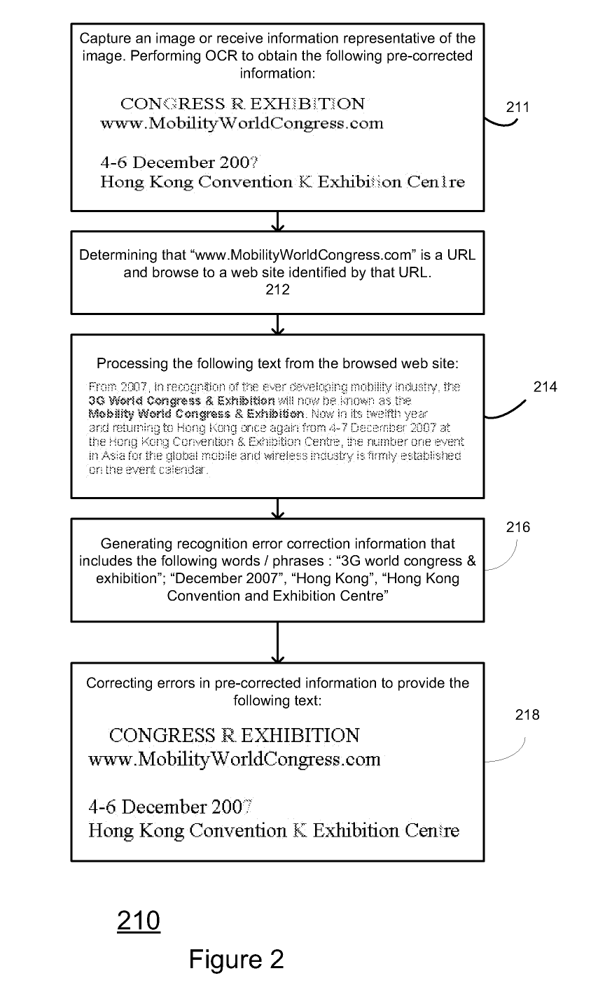

FIGS. 2-4 illustrate methods for providing recognition error correction information according to an embodiment of the invention.

FIG. 2 illustrates process 210. Process 210 starts by stage 211 of capturing an image or receive information representative of the image. Performing OCR to obtain pre-corrected information. The pre-corrected information includes at least one missing symbol and includes few letters that were recognized at a relatively low priority.

Stage 211 is followed by stage 212 of determining that “www.MobilityWorldCongress.com” is a URL and browse to a web site identified by that URL.

Stage 212 is followed by stage 214 of processing text from the browsed web site.

Stage 214 is followed by stage 216 of generating recognition error correction information that includes the following words/phrases: “3G world congress & exhibition”; “December 2007”, “Hong Kong”, “Hong Kong Convention and Exhibition Centre”.

Stage 216 is followed by stage 218 of correcting errors in pre-corrected information to correct errors. It is noted that the correction can include selecting between words in a dictionary or a lexicon based upon recognition error correction information. For example, if an automatic speech recognition entity has to select between “screen” and “spline” (both are in the vocabulary) and the speech signals were captured in the context of “buying a computer”, it is more probable that the right transcription is “screen”.

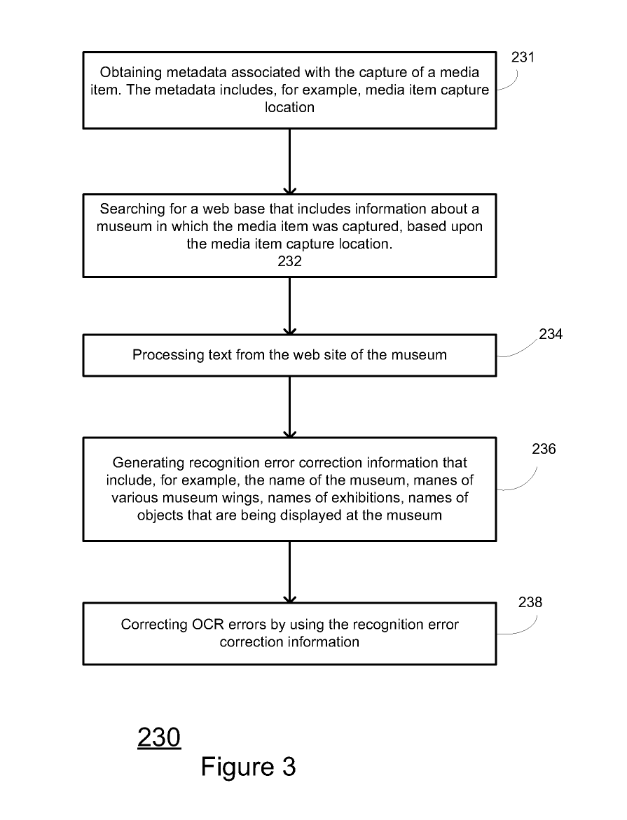

FIG. 3 illustrates process 230. Process 230 starts by stage 231 of obtaining metadata associated with the capture of a media item. The metadata includes, for example, media item capture location.

Stage 231 is followed by stage 232 of searching for a web site base that includes information about a museum in which the media item was captured, based upon the media item capture location.

Stage 232 is followed by stage 234 of processing text from the web site of the museum.

Stage 234 is followed by stage 236 of generating recognition error correction information that include, for example, the name of the museum, manes of various museum wings, names of exhibitions, names of objects that are being displayed at the museum.

Stage 236 is followed by stage 238 of correcting OCR errors by using the recognition error correction information.

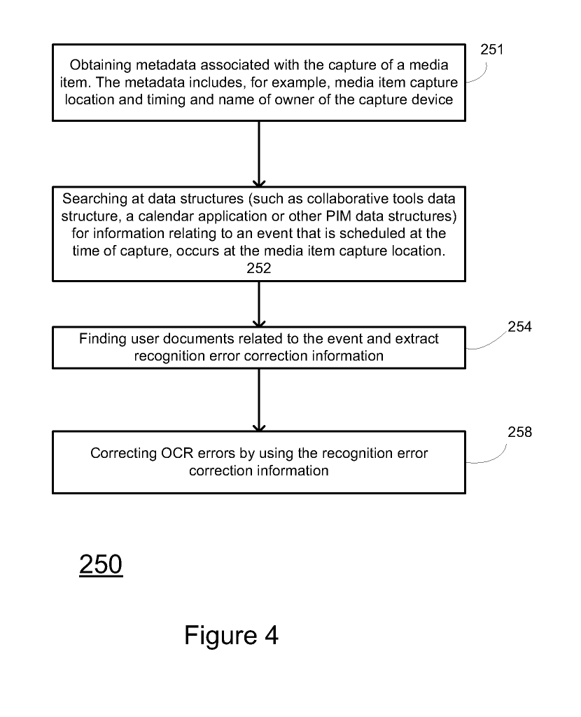

FIG. 4 illustrates process 250. Process 250 starts by stage 251 of obtaining metadata associated with the capture of a media item. The metadata includes, for example, media item capture location, media item capture time and name of owner of the capture device.

Stage 251 is followed by stage 252 of searching at data structures (such as collaborative tools data structure, a calendar application or other PIM data structures) for information relating to an event that is scheduled at the media item capture time, occurs at the media item capture location.

Stage 252 is followed by stage 254 of finding user documents related to the event and extract recognition error correction information.

Stage 254 is followed by stage 258 of correcting OCR errors by using the recognition error correction information.

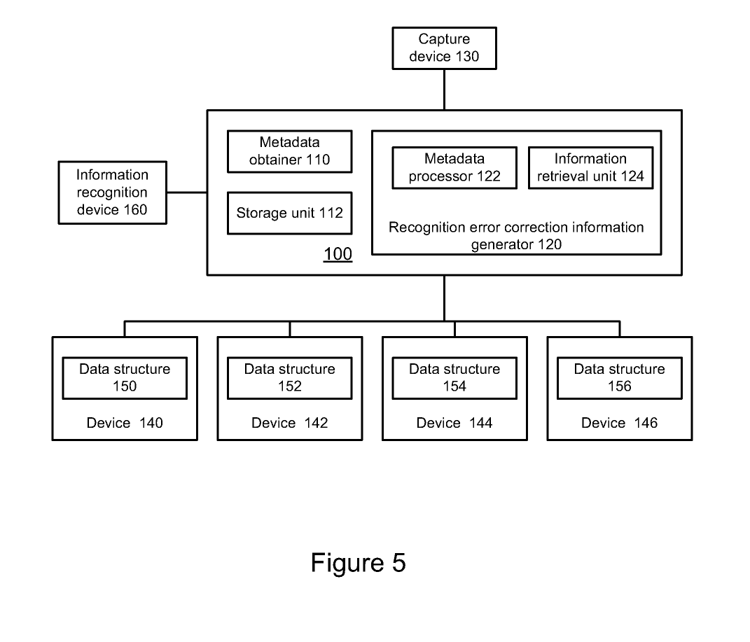

FIG. 5 illustrates system 100 for providing recognition error correction information.

System 100 includes: (i) metadata obtainer 110 that obtains metadata associated with a capture of a media item, (ii) storage unit 112 for storing recognition error correction information, and (iii) recognition error correction information generator 120 that is adapted to generate recognition error correction information in response to the metadata.

System 100 is connected to capture device 130 and to one or more devices (such as devices 140, 142, 144 and 146) that store data structures (such as data structures 150, 152, 154 and 156).

Device 140 can be a mail server that stores emails of multiple users. These emails form data structure 150.

Device 142 can be a server that hosts multiple web sites. These web sites form data structure 152.

Device 144 can store PIM application information (that form data structure 154).

Device 146 can be a shared storage device that stored documents of multiple users.

It is noted that additional or alternative devices can be connected to system 100 and that these various devices can be connected to each other in various manners. For example, system 100 can also be connected to a personal device of the user.

Capture device 130 provide metadata to system 100.

Recognition error correction information generator 120 includes metadata processor 122 and information retrieval unit 124.

Metadata processor 122 receives metadata from metadata obtainer 110 and selects which data structure to access. Metadata processor 122 is connected to information retrieval unit 124.

Information retrieval unit 124 accesses selected data structures and retrieves from these data structures recognition error correction information.

Information retrieval unit 124 can read a data structure (or a portion thereof) and can select which information to retrieve from the selected data structures. The selection can include determining whether a selected data structure includes words or terms that do not exist (or at least are not likely to exist) in a “standard” or non-contextual dictionary used for correcting OCR errors or in vocabulary used for correcting ASR errors. Such words or terms can include names of persons, names of events (such as conferences), names of buildings, domain names, brand names, name of products, abbreviations, slang, technical terms, and the like.

System 100 is further connected to information recognition device 160. Information recognition device 160 can be an OCR tool, an ASR tool and the like. Information recognition device 160 can generate pre-corrected information from the media item. It is noted that system 100 can have information recognition capabilities and can be integrated with information recognition device 160.

Pre-corrected information can be corrected by using one or more dictionaries. One of these dictionaries can include the recognition error correction information while other dictionaries can include non-contextual information, although this is not necessarily so.

Information recognition device 160 can correct the pre-corrected information by using recognition error correction information from system 100 and even by using another dictionary.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for providing recognition error correction information, the method comprises:
obtaining metadata associated with a capture of a media item; and
generating, in response to the metadata, recognition error correction information to be used in a recognition process selected out of a list consisting of an automatic speech recognition process and an optical characters recognition process.

2. The method according to claim 1 further comprising correcting errors of an information recognition process based upon the recognition error correction information.

3. The method according to claim 1 comprising finding at least one data structure that is associated with the metadata and retrieving recognition error correction information from the at least one data structure.

4. The method according to claim 3 comprising retrieving recognition error correction information from a personal information management data structure of a person that is identified by the metadata; wherein the retrieving is responsive to at least one characteristic out of a media item capture time and a media item capture location.

5. The method according to claim 1 comprising retrieving recognition error correction information from a web site that is identified by the metadata.

6. The method according to claim 1 comprising obtaining pre-corrected information from the media item; and generating recognition error correction information in response to the pre-corrected information.

7. The method according to claim 1 comprising determining an event during which the media item was captured and generating recognition error correction information based upon at least one characteristic of the event.

8. The method according to claim 1 comprising retrieving recognition error correction information in response to setting information of a capture device during a capture of the media item.

9. The method according to claim 1 comprising correcting errors of an automatic speech recognition process.

10. The method according to claim 1 comprising correcting optical characters recognition errors.

11. A computer program product comprising a computer usable medium including a computer readable program, wherein the computer readable program when executed on a computer causes the computer to:
obtain metadata associated with a capture of a media item;
generate, in response to the metadata, recognition error correction information to be used in a recognition process selected out of a list consisting of an automatic speech recognition process and an optical characters recognition process.

12. The computer program product according to claim 11 that causes the computer to correct errors of an information recognition process that based upon the recognition error correction information.

13. The computer program product according to claim 11 that causes the computer to find at least one data structure that is associated with the metadata and retrieving recognition error correction information from the at least one data structure.

14. The computer program product according to claim 11 that causes the computer to retrieve recognition error correction information from a personal information management data structure of a person that is identified by the metadata; wherein the retrieval is responsive to at least one characteristic out of a media item capture time and a media item capture location.

15. The computer program product according to claim 11 that causes the computer to retrieve recognition error correction information from a web site that is identified by the metadata.

16. The computer program product according to claim 11 that causes the computer to obtain pre-corrected information from the media item; and generate recognition error correction information in response to the pre-corrected information.

17. The computer program product according to claim 11 that causes the computer to determine an event during which the media item was captured and generate recognition error correction information based upon at least one characteristic of the event.

18. The computer program product according to claim 11 that causes the computer to retrieve recognition error correction information in response to setting information of a capture device during a capture of the media item.

19. The computer program product according to claim 11 that causes the computer to correct errors of an automatic speech recognition process.

20. The computer program product according to claim 11 that causes the computer to correct optical characters recognition errors.
